(19) United States
(12) Patent Application Publication
(10) Pub. No.: US 2024/0199906 A1
(43) Pub. Date: Jun. 20, 2024

(54) A HIGH-PERFORMANCE NON-CONDUCTIVE POLYMER MATERIAL FOR ELIMINATION OF ELECTROSTATIC CHARGE AT SOURCE

(71) Applicants: NATIONAL UNIVERSITY OF SINGAPORE, Singapore (SG); SINGAPORE INSTITUTE OF TECHNOLOGY, Singapore (SG)

(72) Inventors: Siow Ling SOH, Singapore (SG); Shin Yee WONG, Singapore (SG); Neriah Yan Jie TAN, Singapore (SG); Teng Shuen Ernest LIM, Singapore (SG)

(21) Appl. No.: 18/556,046

(22) PCT Filed: Apr. 19, 2022
(86) PCT No.: PCT/SG2022/050232

§ 371 Date: Oct. 18, 2023

(30) Foreign Application Priority Data
Apr. 19, 2021 (SG) 10202104005V

(51) Int. Cl. C09D 131/04; B05D 3/14; C08J 7/04; C08J 7/044; C09D 5/00; C09D 7/20; C09D 127/16; C09D 171/02

(52) U.S. Cl. CPC C09D 131/04; B05D 3/142; C08J 7/0427; C08J 7/044; C09D 5/00; C09D 7/20; C09D 127/16; C09D 171/02; C08J 2323/06; C08J 2323/12; C08J 2367/02; C08J 2427/16; C08J 2431/04; C08J 2471/02

(57) ABSTRACT

The present invention relates to a non-conductive polymer material for applying a non-conductive coat to a surface, The non-conductive polymer material comprises a first polymer selected from the group consisting of polyvinyl acetate and polyethylene oxide; a second polymer being polyvinylidene fluoride; and a solvent selected from the group consisting of dimethyl sulfoxide, tetrahydrofuran, toluene and dimethylformamide. The present invention also relates to a method of eliminating electrostatic charge on a surface by applying the non-conductive polymer material of the present invention to at least one surface of an object to form a non-conductive coat on the surface.

### FIELD OF THE INVENTION

The present invention relates to a high-performance non-conductive polymer material for elimination of electrostatic charge at source and a method of applying the same on a surface. In particular, the present invention relates to a high-performance non-conductive polymer material comprising at least two polymers and a solvent, and a method of applying the non-conductive polymer material on a surface to eliminate electrostatic charge at source for preventing fouling and improving industrial productivity.

### BACKGROUND

Contact electrification is the phenomenon in which static charge is generated when two solid surfaces come into contact and are then separated. Almost all types of materials charge highly by contact electrification; hence, the phenomenon is ubiquitous in industry and our lives. However, static charge on surfaces is undesirable in many cases. It may cause unwanted adhesion, reduction in efficiency of manufacturing processes, electrostatic discharge, and even explosion. The problems created by contact electrification become greatly amplified when particles are involved. Due to the high surface area-to-volume ratio of particles, particles have the great tendency to accumulate large amounts of charge on their surfaces. In addition, adhesion becomes a dramatically more severe problem due to their small sizes; hence, attractive electrostatic forces tend to dominant (e.g., over gravitational forces due to their weights). In this case, severe adhesion occurs. Therefore, there is a great need to find solutions to prevent static charge from being generated on particles by contact electrification.

In practice, static charge generated on particles can cause a vast range of issues across many different industries. Unwanted adhesion of particles on surfaces, for example, is highly undesirable. For the manufacturing of microelectronics, only a single adhered particle is needed to be a “killer defect”: by causing an open or a short circuit that results in device failure. In optics, cleanliness of surfaces is necessary to maintain high load performance of optical and electromechanical components in high powered solid-state laser facilities. For solar energy harvesting, adhesion of dust particles on the surface of solar panels is a severe and common problem of the panels and can significantly reduce the energy harvested from the sun. In pharmaceutical industry, the aggregation of drug particles due to electrostatic forces can lead to non-uniform blending and inaccurate dosages of the drug products. Inaccurate dosages are known to be one of the main factors in causing unnecessary adverse health reactions and even deaths. In our daily lives, adhesion of dust particles is also frequently encountered, such as on surfaces of furniture and on screens of computers and phones.

Severe forms of adhesion of particles on surfaces lead to fouling: the build-up of a thick and hard layer of coating on the surface. Fouling causes many types of problems in industry. Importantly, fouling can form on many types of common materials used in industry (e.g., stainless steel, glass, and polymers) and different parts of the operation, including pipelines, funnels, walls of vessels, and many other parts of the manufacturing plant. Fouling causes clogging, which in turn often requires the production to halt for cleaning and de-clogging the surfaces. Halting the production results in huge losses of productivity, time, and cost to companies. Another major issue involves process analytical tools (PAT) (e.g., near-infrared) for analyzing the properties (e.g., moisture) of particles in a process. Fouling often covers up the sensor and interferes with the continuous monitoring of the probe in the production line, thus rendering the detection ineffective. In addition, fouling of the walls of vessels (e.g., of reactors) can prevent effective heat transfer. Excessive accumulation of charge can lead to electrostatic discharge (e.g., sparks). Electrostatic discharge can cause damage to equipment; these damages are reported to cost the electronic industry billions of dollars per year. Importantly, electrostatic discharge can cause explosions of flammable gases, dusts, and organic liquids.

The most common method used for preventing the accumulation of charge on surfaces is to use conductive materials. This general approach includes either the direct use of conductive materials or increasing the conductivity of insulating materials (e.g., via the doping of conductive additives into the material or coating the surface with hygroscopic materials). By grounding the materials with high conductivity, the static charge generated on the surfaces can be dissipated away rapidly. However, the problem in most types of industries is that the particles involved are usually insulating and cannot be modified to be conductive (e.g., food or drug particles). When the insulating particles contact against a grounded conductive surface, the charge generated remains on the surface of the insulating particle (even as the charge is dissipated to ground on the conductive surface); hence, grounding of conductive surface is not an effective method for preventing the charging of insulating particles. Nevertheless, this approach is still currently widely used in industry possibly because of historical considerations rather than effectiveness. Other methods have also been proposed for eliminating the accumulation of static charge, including the use of electrostatic guns, doping of radical scavengers, or simply allowing the charge to dissipate naturally from the particles with time. These methods, however, cannot eliminate charge adequately and are especially ineffective for particles. In general, particles have a high tendency to move across large distances due to agitation, collide with surfaces frequently, and charge highly upon contact due to their high surface area-to-volume ratio; hence, it has been extremely challenging to devise methods to eliminate charging, and the undesirable consequences of contact electrification of particles against surfaces.

It is therefore desirable to provide a material and a method that seek to address at least one of the problems described hereinabove, or at least to provide an alternative.

### SUMMARY OF INVENTION

According to a first aspect of the present invention, a non-conductive polymer material for applying a non-conductive coat to a surface is provided. The non-conductive polymer material comprises a first polymer selected from the group consisting of polyvinyl acetate and polyethylene oxide; a second polymer being polyvinylidene fluoride; and a solvent selected from the group consisting of dimethyl sulfoxide, tetrahydrofuran, toluene and dimethylformamide.

According to a second aspect of the present invention, a method of eliminating electrostatic charge on a surface is provided. The method comprises applying at least one layer of a non-conductive polymer material comprising a first polymer selected from the group consisting of polyvinyl acetate and polyethylene oxide, a second polymer being polyvinylidene fluoride; and a solvent selected from the group consisting of dimethyl sulfoxide, tetrahydrofuran, toluene and dimethylformamide, to at least one surface of an object to form a non-conductive coat on the surface.

In accordance with one embodiment of the present invention, the method further comprises subjecting the at least one surface to plasma treatment prior to applying the non-conductive polymer material on the at least one surface of the object.

In accordance with one embodiment of the present invention, the method comprises applying the at least one layer of the non-conductive polymer material to the at least one surface made of material selected from the group consisting of thermoplastic polymer, stainless steel and glass.

### BRIEF DESCRIPTION OF THE DRAWINGS

FIG. 1 shows the strategy for fabricating polymeric surfaces that do not charge against particles. (a) The strategy involves blending Polymer (A) that tends to charge positively and Polymer (B) that tends to charge negatively against the particles in an appropriate proportion for preparing a non-charging Polymer (N). Particles do not charge and stick on the non-charging polymer.

FIG. 2 shows fabrication of non-charging surface for applications. (a) Coating on substrate materials including stainless steel (1), glass (2) and polypropylene (3); (b) Unique structures of the substrates; cups with walls (1), watch glass with curved surface (2) and housing with flat surface (3).

FIG. 3 shows an automated setup (prototype) to coat a long length of cover tape continuously. The setup includes a syringe pump 30, a tube holder 31, a heat gun 32, a power source 33, a motor and housing 34, a speed controller 35, a guide rails 36, and cover tape 37.

FIG. 4 shows integrated circuits clinging onto the cover tape.

FIG. 5 shows the static charge on the chips during normal removal operation; chips that clung onto regular tape has significantly higher static charge than those that do not. (Chips dimensions: 4 mm×4 mm and weight of 0.417 g ).

FIG. 6 shows the charge of the integrated circuit (IC) chips when non-charging cover tape was used (chips dimensions: 4 mm×4 mm and weight of 0.417 g ).

FIG. 7 is a chart showing the electrostatic charge of pure polyethylene terephthalate (PET) sheets with 0, 1 and 2 sides coated.

FIG. 8(i) shows the electrostatic charge of ethylcellulose powder agitated against regular and non-charging stainless steel cups; and (ii) a visual representation of the extent of fouling.

FIG. 9 is a chart showing the charge on IC chips (dimensions 2.5 mm×1.5 mm) packaged in non-charging and regular tape.

FIG. 10 shows the results obtained to illustrate contact electrification on coated surfaces. (a)(i) Charge of ethylcellulose powder against different percentages of PVAc contained in the polymer material that was coated onto the stainless steel surfaces (a)(ii) Images of powder remaining on coated surface (b)(i) Comparison of charge of ethylcellulose powder after agitation against 80% PVAc surface and against bare stainless steel surface, respectively. (b)(ii) Images of powder remaining on coated surface and bare stainless steel. (c)(i) Charge of milk powder against different percentages of PVAc contained in the polymer material that was coated onto the stainless steel surfaces. (c)(ii) Images of powder remaining on coated surface. (d) Average final surface charge after contacting with milk powder on uncoated, manually coated and dip coated stainless steel plate surfaces respectively.

FIG. 11 shows powder adhesion on surfaces is minimal without agitation. (a) Percentage mass of powder adhesion of ethylcellulose powder with respective images on PVAc-PVDF blend coated watch glass after being in contact with aspirin powder and flipped immediately without agitation (b) Percentage mass of powder adhesion of aspirin powder with respective images on PEO-PVDF blend coated watch glass after being in contact with aspirin powder and flipped immediately without agitation. (c) Percentage mass of powder adhesion of aspirin powder with respective images on PVAc-PVDF blend coated stainless steel cups after being in contact with aspirin powder and flipped immediately without agitation (d) Percentage mass of powder adhesion of aspirin powder with respective images on PVAc-PVDF blend coated stainless steel cups after being in contact with ethylcellulose powder and flipped immediately without agitation.

FIG. 12 shows the characterization of coating. (a) Elemental analysis. Carbon and Oxygen were detected while no fluorine was detected, for all samples. (b) Surface roughness profile (c) Effect of humidity (i) Charge of ethylcellulose after agitation at different humidity (ii) Charge of milk powder after agitation at different humidity.

FIG. 13 shows (a)(i) Charge per mass of aspirin powder after being agitated on PVAc-PVDF blend coated watch glass (ii) Percentage mass of powder adhesion and (iii) its respective images (b)(i) Charge per mass of ethylcellulose powder after being agitated on PEO-PVDF blend coated watch glass (ii) Percentage mass adhesion of ethylcellulose powder and (iii) its respective images.

FIG. 14 shows the results obtained from the experiment described in Example 3(iii) on bulk contact of PVC with coated housing and powder-surface dynamics. (a) Charge density of housing and PVC against percentage of PVAc after bulk contacting each other 50 times (b) Charge density of polymer-coated housing against percentage of PVAc (c) Amount of powder adhered to polymer-coated housing (d) Average final surface charge after contacting with milk powder on uncoated and coated polypropylene surfaces respectively (e) Average % adhesion of various protein powders on regular and non-charging centrifuge tubes respectively.

FIG. 15 shows the results obtained from the experiment described in Example 3(iii) on fouling causing blocking of NIR signal resulting in inaccurate measurement of moisture content. (a) Without housing, lower percentage of moisture content (˜2.5%) was measured using the same 5% moisture content of the aspirin powder. With housing, the percentage moisture content measured before and after agitation remained relatively the same (b) Fouling occurred after agitation with powder, (c) With housing, no occurrence of fouling after agitation.

FIG. 16 illustrates the method of monitoring moisture content in aspirin powder using commercially available glass filter dryer and NIR prove. (a) shows a NIR probe without housing. Fouling occurs where aspirin powder adhered to the probe tip. (b) shows a custom-made polypropylene housing 161 coated with non-charging polymer blend to be tight fitted onto the NIR probe 162. (c)(i) shows a Glass Filter Dryer (GFD) set-up 163. (c)(ii) illustrates the step of pouring aspirin powder and water into the GFD. (c)(iii) illustrates a step that involves continuous moisture content measurement by NIR probe 162 and concurrent manual measurement of moisture content every 5 min. (d) Three continuous batches of Glass Filter Drying with housing. (Right) No fouling on coated housing even after 3 batches of drying.

FIG. 17 is a chart showing the comparison of average percentage (%) adhesion of powders between regular and non-charging tubes for seven different types of protein powders.

### DETAILED DESCRIPTION OF THE PREFERRED EMBODIMENTS

The present invention provides a high-performance non-conductive polymer material for forming a non-charging coat on a surface. The surface coated with the non-conductive polymer material do not charge when in contact with any particles or powders and importantly, both the surface and the particles or powders do not charge by contact electrification. The non-conductive polymer material eliminates electrostatic charge at source to prevent fouling and improve industrial productivity.

Charging of particles is tremendously more complicated and unpredictable than charging of macroscopic surfaces. Many reasons contribute to the challenges in understanding the charging of particles, including the complex dynamics of granular flows of microscopic particles and the natural tendency of particles to charge readily and highly. In addition, interactions among the particles involve multiple natural phenomena acting at the same time (for example, “contact de-electrification”) and can also result in interesting ensemble charging effects of the particles. Moreover, particles are generally very fine and light. They fly and adhere onto surfaces easily. Some particles change properties when the environment changes, making the challenge ubiquitous. Because of these special characteristics of particles, it is hard to predict their behaviour. The present invention provides an effective solution for preventing the charging of particles. In the present invention, a novel non-conductive polymer material capable of preventing the charging of particles against surfaces by contact electrification is found.

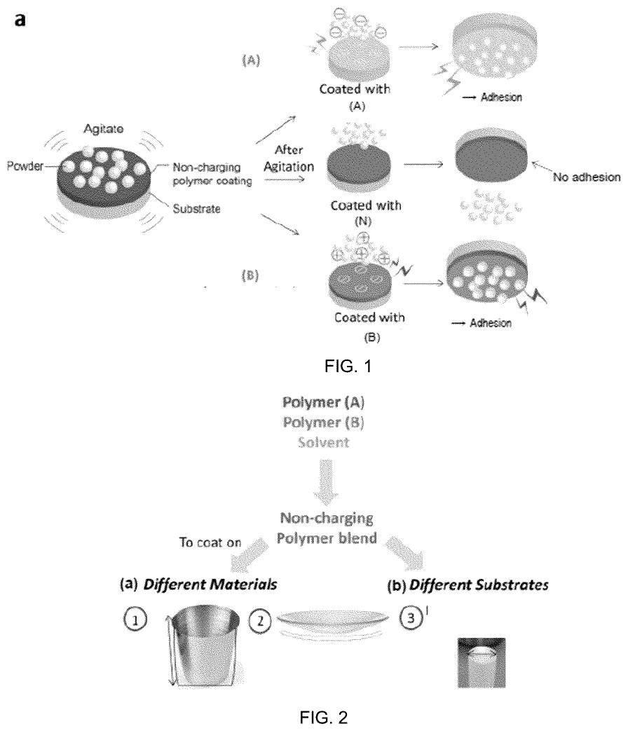

The approach first involves selecting two polymers: a first polymer charges positively against a specifically targeted type of particles (“Polymer (A)” in FIG. 1a) and a second polymer charges negatively against the particles (“Polymer (B)” in FIG. 1a). By blending these two types of polymers together at a suitable proportion of the two polymers, a non-conductive polymer material (N) is formed and using the non-conductive polymer material, a polymeric surface that resists charging against the particles can be fabricated.

In particular, the non-conductive polymer material comprises a first polymer selected from the group consisting of polyvinyl acetate (PVAc) and polyethylene oxide (PEO) and a second polymer being polyvinylidene fluoride (PVDF) and a solvent selected from the group consisting of dimethyl sulfoxide (DMSO), tetrahydrofuran (THF), toluene and dimethylformamide (DMF).

The non-conductive polymer material may comprise an appropriate proportion of the first polymer and the second polymer such that the polymer material resists charging against another material. The proportion of the first polymer and the second polymer comprised in the polymer material may vary depending on the surface that the polymer material is to be applied to or the material, particles or powders that the polymer material is to be in contact with. In various embodiments, the weight proportion of the first polymer in the polymer material may be 40% to 85%, 45% to 80% by weight based on the total weight of the polymer material. In various embodiments, polymer material comprises polyvinyl acetate (PVAc) and polyvinylidene fluoride (PVDF). In these embodiments, the weight proportion of PVAc in the polymer material may be 40% to 85% by weight based on the total weight of the polymer material. In some embodiments, 40% to 50%, 45% to 50%, 55% to 70%, 75% to 85%, 80% to 85% based on the total weight of the polymer material. In various embodiments, the polymer material comprises polyethylene oxide (PEO) and polyvinylidene fluoride (PVDF). In these embodiments, the weight proportion of PEO in the polymer material may be 55% to 70%, 60% to 65% by weight based on the total weight of the polymer material.

The non-conductive polymer material of the present invention is prepared by blending the first polymer and the second polymer in desired proportion in the solvent. In an embodiment, the non-conductive polymer material is prepared by dissolving the first polymer in the solvent and dissolving the second polymer in the same solvent separately before blending the first polymer with the second polymer in desired proportion.

The non-conductive polymer material is in liquid form and can be coated on different types of surfaces to eliminate electrostatic charge at source. Suitable surfaces include, but are not limited to, thermoplastic polymer including, but not limited to, polypropylene, polyethylene and polyethylene terephthalate, an alloy such as stainless steel, and glass, etc. The polymer material can also be coated on surfaces of different geometries and structures including, but are not limited to, internal and/or external surfaces of a receptacle of any shapes and sizes, a curved surface, a flat surface, etc. (FIG. 2).

As used herein, “receptable” refers to a hollow object used to contain something and it includes, but not limited to, vessel, container, holder, drum, hopper, reactor, bag, cup, bowl, etc.

The non-conductive polymer material can effectively prevent the charging of particles or powders and the adhesion of the particles or powders to the surfaces. In an exemplary embodiment, the non-conductive polymer material can eliminate electrostatic charge on a thermoplastic polymer surface of a cover tape on a packaging material to prevent static adhesion of integrated circuit (IC) chips (i.e., metal wires embedded in epoxy covering) on the packaging material. In another exemplary embodiment, the non-conductive polymer material can prevent fouling caused by powder blending or powder post-processing in a stainless steel receptable. In yet another exemplary embodiment, the non-conductive polymer material can eliminate electrostatic charge on a Process Analytical Tools (PAT) probe caused by powder in a continuous batch drying process (via a standard glass filter dryer, GFD).

In accordance with a second aspect of the present invention, a method of eliminating electrostatic charge on a surface is provided. The method comprises the step of applying at least a layer of the polymer material of the present invention on at least one surface of an object to form a non-conductive coat on the surface. The at least one surface includes, but is not limited to, thermoplastic polymer, such as polypropylene, polyethylene, polyethylene terephthalate, an alloy, such as stainless steel, and glass, etc.

In one embodiment, the method further comprises subjecting the at least one surface to plasma treatment prior to applying the polymer material on the at least one surface of the object.

### IC Chips

In one embodiment, the method comprises the step of applying at least a layer of the polymer material of the present invention on a thermoplastic polymer surface to prevent electrostatic charge on the thermoplastic polymer surface. In an exemplary embodiment, the method includes applying at least a layer of the polymer material on a thermoplastic polymer surface of a cover tape on a packaging material to prevent static clings of integrated circuit (IC) chips on the packaging material. In this embodiment, the thermoplastic polymer surface is subjected to plasma treatment prior to applying the polymer material on the thermoplastic polymer surface. The thermoplastic polymer can be polyethylene terephthalate (PET), polyethylene (PE) or the like.

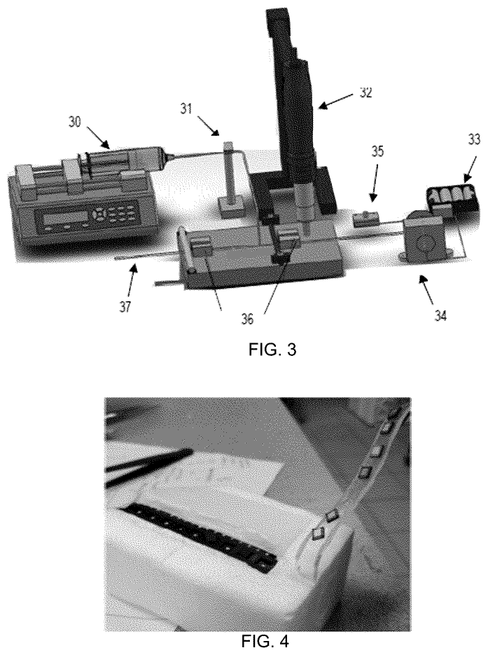

The inventors found that the duration of plasma treatment affects the charging property of the polymer material coating with the IC chips, and a 5-minute plasma gives the coated cover tape an ideal charging property and is also a short enough duration to allow the coating to be well wetted onto the whole surface. FIG. 3 illustrates an exemplary setup for coating a length of cover tape continuously. The polymer material is coated onto the cover tape by having a speed controller 35 motor roller spooling the cover tape 37 at a consistent speed of about 7.5 mm/s while the polymer material is applied onto the surface of the cover tape at a rate of 0.08 mL/min. This rate of dispensing the polymer material solution results in an ideal coating thickness, uniformity and without excess flowing from the edges, right after the dispensed solution was spread by the rod and coated onto the surface. The drying using a heat gun 32 allows the automation to continue and the high heat of 100° C. allows the drying to be extremely fast and the coating to remain transparent on the cover tape surface. The high temperature is also required for ideal charging property. The solution needs to be dried immediately after the spreading of the solution in order for the coating to remain transparent on the cover tape. Transparency is a required property of the cover tape. In an embodiment, the tape is coated with the polymer material in small sections with drying done immediately after the spreading of the polymer material. This method can produce a good coating even without the use of plasma treatment. Further details of this embodiment will be described in greater detail in the Examples below.

As opposed to existing methods that use conductive methods to conduct charge away, the present invention works by eliminating the generation of electrostatic charge at source. With the use of the polymer material of the present invention in accordance with the method described hereinabove, several commercial problems can be alleviated or solved by this embodiment. Firstly, the method prevents damage of the IC chips. The elimination of static charge generation can prevent electrostatic discharge (ESD) sensitive IC chips from getting damaged by static charge. Secondly, the method eliminates or reduces productivity loss. The surface mount technology (SMT) machine shutdowns automatically whenever the IC chips are stuck onto the cover tape due to static charge during peel-off process. The downtime is costly and it is estimated to be at least one million dollars a year. Thirdly, the method helps to reduce maintenance cost. It reduces the need or frequency to reset the operation of the SMT machine due to IC chips being stuck onto the cover tape. Each reset of the operation requires repositioning of the IC chips manually, which can be time-consuming.

### Fouling

In another embodiment, the method relates to applying at least a layer of the polymer material of the present invention on at least one surface of an object to prevent fouling of powders on the surface.

Contact electrification is the phenomenon in which static charge is generated when two solid surfaces come into contact. The problems created by contact electrification become greatly amplified when particles are involved. Due to the high surface area-to-volume ratio, particles have tendency to accumulate large amounts of electrostatic charge on their surfaces. When the highly charged particles come into contact with the surroundings (e.g. vessel's wall, agitator, etc.), attractive electrostatic forces tend to dominate (over gravitational forces), resulting in the adhesion of particles. As more particles build up, thick layers of particles will form, leading to fouling on surfaces. This is a major problem for companies dealing with powder blending or powder post-processing. After fouling occurs, the operator will be forced to shut down the process for cleaning (after a few batches). Depending on the extent of fouling and the adhesion of particles to the vessel wall, the cleaning activities will often require manual intervention. The operator might have to descend into the vessel to remove the fouled powder using manual brushing. To increase productivity, there is a need to tackle the fouling issue using fundamental principles.

In an embodiment, the method comprises the step of applying at least a layer of the polymer material of the present invention on a stainless steel surface to prevent electrostatic charge on the stainless steel surface. The stainless steel surface may be any surface that comes into contact with powders of any form, for example, an internal surface of a receptacle for receiving the powders. The receptacle may be of any form, shape and size.

In an embodiment, the method comprises the step of applying at least a layer of the polymer material of the present invention on a thermoplastic polymer surface to prevent electrostatic charge on the thermoplastic polymer surface. In an exemplary embodiment, the method comprises the step of applying the polymer material on the surface of a polypropylene sleeve (housing) of a PAT probe.

The non-conductive polymer material of the present invention is highly versatile and can be flexibly applied to surfaces of virtually any type of materials, forms, shapes and sizes. Importantly, the polymer material is able to coat well on materials which are common industrial equipment surfaces like stainless steel. The polymers used are FDA-approved pharma and food contact materials, and the method through which the blend of polymer material is formulated does not require additional regulatory approval. Hence, the polymer material is ready and safe to be applied onto current existing facilities in the pharmaceutical and food manufacturing processes dealing with various types of powders to prevent fouling. The solution offers by the present invention provides a way for total elimination of electrostatic charge to be realized and made possible.

To facilitate a better understanding of the present invention, the following examples of specific embodiments are given. In no way should the following examples be read to limit or define the entire scope of the invention. One skilled in the art will recognize that the examples set out below are not an exhaustive list of the embodiments of the present invention.

### EXAMPLES

### Materials and Methods

Materials. Polyvinyl acetate (PVAc, M_{w}=100,000), polyethylene oxide (PEO, M_{w}=100,000), polyvinylidene fluoride (PVDF, M_{w}=180,000), aspirin powder were purchased from Sigma Aldrich. Ethylcellulose powder was purchased from Ashland Singapore. Dimethylformamide (DMF) was purchased from VWR Chemicals. Milk powder (Fairprice High Calcium Adult Milk-Based Powder) was purchased from the local hypermarket NTUC Fairprice in Singapore. Stainless steel cups (Ø6.5×H6 cm; SS304) were purchased from Sia Huat Pte Ltd. Polypropylene housing was fabricated by Microtech Engineering Pte Ltd.

### Example 1

### Process of Coating Different Types of Surfaces

### (i) Coating a Polyethylene Terephthalate (PET) Surface

The two polymers selected are polyvinyl acetate (PVAc) and polyvinylidene fluoride (PVDF). These two polymers were mixed in a 3:2 ratio and blended in dimethylformamide (DMF) as the common medium to form the coating solution. A non-charging tape was fabricated by coating this blend on the surface of a regular cover tape. The side that was coated was the underside of the cover tape that was in touch with the top surface of the IC chips in a typical carrier and cover tape packaging.

### A1: Pre-Treatment With Plasma

The cover tape was subjected to 5-minute plasma treatment to activate the surface, to enable good wetting of the surface by the polymer blend solution. After plasma treatment, 37.5 μL/cm of the coating solution was dispensed and the cover tape was gently tilted to allow the coating solution to flow, such that the whole inner surface of the cover tape was wetted with a layer of the polymer coating solution. The coated tape was then transferred to an oven for drying at 80° C. for 15 min.

### A2: No Pre-Treatment

37.5 μL/cm of the coating solution was dispensed onto the PET sheet (material for cover tape). Then, the sheet was pulled gently under a spreader rod on the coating board, such that the whole inner surface of the cover tape was wetted with a layer of polymer blend coating solution. The coated tape was then dried immediately under a heat gun at 100° C.

### B. Automated Coating Process

An automated prototype that coats a long length of cover tape continuously using the formulated coating solution is shown in FIG. 3. The prototype setup enabled a long length of cover tape to be coated continuously. A speed controller 35 motor roller pulled the cover tape 37 at a consistent speed of 7.5 mm/s as it was being coated. The non-charging coating solution was dispensed through an automated syringe pump 30, at a rate of 0.08 mL/min prior to the spreader rod. The coating solution was spread evenly through the cover tape as it goes through under the metal spreader rod. Once coated, the cover tape 37 was dried immediately by a heat gun 32 at a temperature 100° C. The heat gun is positioned 4 cm above the coated surface. Once dried, the coated cover tape is rolled up onto the motor 34 where a 3D printed reel and housing was mounted on it.

### (ii) Coating a Stainless Steel Surface

A polymer material comprising PVAc and PVDF was first prepared by dissolving each in DMF with the same concentration of 200 mg/mL and then mixed together in desired proportion to form the coating solution. A stainless steel cup (Ø6.5×H6 cm; SS304) was first subjected to 5-minute plasma treatment to activate the surface for coating. This is to enable good bonding between the polymer material and the surface. Subsequently, 50 mL of the coating solution was then poured into the cup. The cup was gently rotated such that the entire inner surface of the cup was wetted with a layer of the coating solution to create a boundary film surrounding the interior surface. The excess solution was discarded. After that, the cup was inverted and placed in a glass beaker. The glass beaker was then covered with a piece of aluminium foil and the whole assembly was placed in an oven at 80° C. and left to dry overnight.

The same procedure was applied to a stainless steel sheet (3 mm×2.5 cm×7.5 cm). For the stainless steel sheet, the sheet was dipped into the coating solution and pulled out manually for coating.

(iii) Coating a Polypropylene Surface

In this example, a PAT probe was used to demonstrate the method of coating a polypropylene surface. This case study was developed using a Bruker Matrix-F NIR Spectrometer with probe in an aspirin drying process. Firstly, a hollow, cylindrical polypropylene sleeve (housing) was designed to be fitted tightly onto the body of a PAT probe. The tip of the probe was covered with its closed end. The dimension of the housing was 18.4 mm (D)×80 mm (L). Similar to the coating on the stainless steel vessel, the non-charging polymer material was coated onto the housing via plasma treatment, dip coated with the polymer material and dried. The procedures for coating the outer surface of the polypropylene housing include, mixing PVAc and PVDF solutions (100 mg/mL, in DMF) in an appropriate ratio to obtain the desired weight percentage of PVDF versus PVAc. Before coating, the housing was put to plasma treat in a plasma cleaner for 2 minutes. At the same time, the non-charging polymer material (45% PVAC-55% PVDF) was homogeneously heated to 70° C. in a hotplate. When the time of plasma treatment was up, the housing was then slowly dipped into and pulled out from the hot polymer solution using a pair of tweezers. The coated housing was then placed in an oven at 70° C. for about 20 min for the evaporation of the solvent base.

### (iv) Coating a Glass Surface

In this example, a watch glass was used to demonstrate the method of coating a glass surface.

Firstly, PVAc solution (30 wt %, in DMF) and PVDF solution (20 wt %, in DMF) were mixed in an appropriate weight proportion (depending on the weight percentage of PVDF versus PVAc desired). 700 μL of the solution was spread onto the surface of the watch glass (diameter: 45 mm). The spreading was controlled such that the surface was fully covered with the solution. The watch glass with the solution was then spin-coated at 600 rpm for 2 min. The coating was allowed to dry overnight in an oven at 80° C.

For the coating of the polymer blends that consisted of PEO and PVDF onto the surface of the watch glass, the procedure was the same as described above, except that the PVAc solution was replaced with PEO solution (10 wt %, in DMF).

### Example 2

### Contact-Charging Experiments

### (i) Polyethylene Terephthalate (PET) Surface

In the electronics industry, IC chips are first packaged in the semiconductor industry in a carbon black carrier and then sealed with a transparent cover tape. The IC chips are then transported to the electronics assembly. The cover tape will then be peeled off so that the surface mount technology machine can automatically pick up the IC chips from the carrier to be placed in a printed circuit board (PCB). During the peeling process, many IC chips frequently cling onto the cover tape. This pick and place process in the industry was simulated in the laboratory and confirmed with the results as illustrated in FIG. 4. If the IC chips are stuck onto the cover tape, the pick and place machine will not be able to pick up the chips from the assigned slots (in the carrier tape). As a result, the surface mount technology machine will shut down automatically (due to missing components). To reset, the operator has to reposition the chips manually. The downtime is costly, estimated to be at least one million dollars a year.

### Simulation of Chips Sticking and Charge Measurement

A laboratory simulation of the industrial chip's pick and place process was conducted. The IC chips were first packed into the carrier, and then sealed with the cover tape. The top of the cover tape was rubbed against the glove for 10 times (to mimic the transportation process). Once it reached the “assembly line”, the cover tape was peeled off from the carrier.

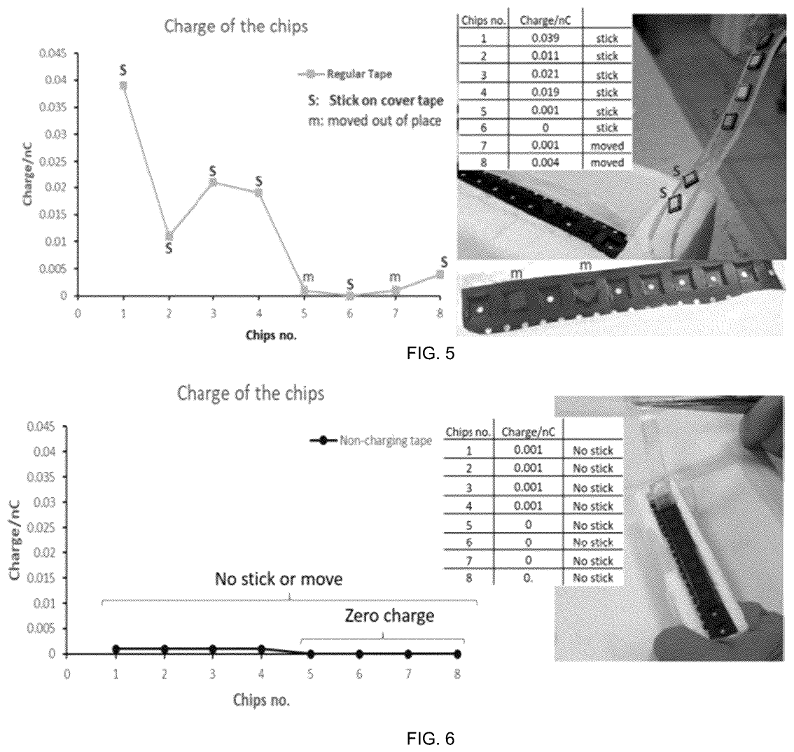

During this simulation, the inventors found that IC chips tend to cling regularly onto the cover tape when it is being peeled off from the carrier (FIG. 5, ‘S’). Other chips that do not cling to the cover tape moved out of place (FIG. 5, ‘M’). The electrostatic charge of every chip was also measured by picking the chip with a plastic tweezer and then dropping it into a Faraday cup connected to an electrometer (Keithley 6514). The chips that clung onto the cover tape was found to have significantly higher charge than those that did not. The charge measurement data is shown in FIG. 5.

A polymer material comprising PVAc and PVDF in a weight ratio of 3:2 blended in DMF was prepared and coated onto a cover tape (dimensions: 8 cm×1 cm) using the manual coating process that comprises pre-treatment with plasma method as described in Example 1(i) to form a non-charging cover tape. The side that was coated was the underside of the cover tape that was in contact with the top surface of IC chips in a typical carrier and cover tape packaging. When the non-charging cover tape was used in the simulation of the chip's pick and place process, the chips did not stick nor move out of place (FIG. 6). The charge of the chips when the non-charging cover tape was used was also mostly zero or very close to zero. Compared to the electrostatic charge of the chips packaged in regular cover tape (FIG. 5), the charge of the chips packaged in non-charging cover tape was significantly lower.

### Charge Measurement on Non-Charging PET Sheets

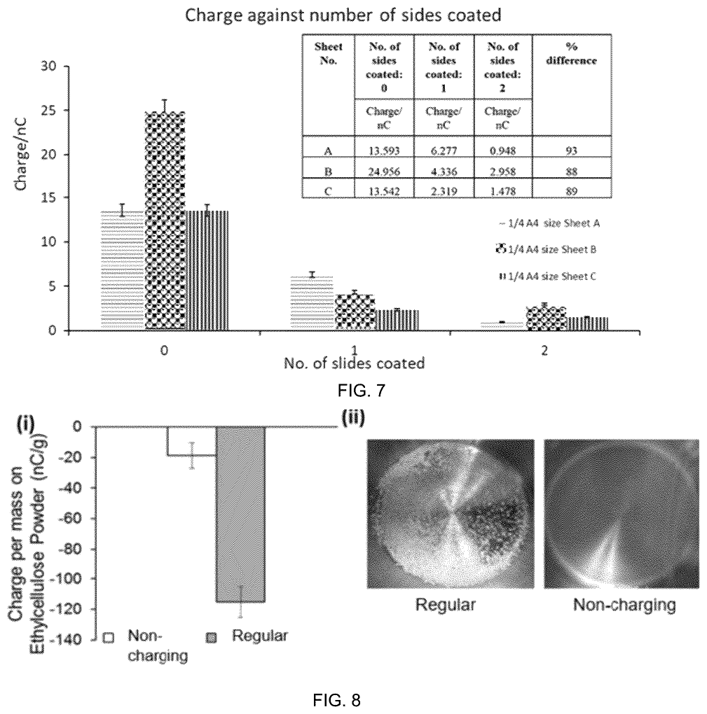

The regular cover tape consists of three materials, namely polyethylene terephthalate (PET), polyethylene (PE), and sealant. The formulated non-charging coating solution was applied on PET sheets to assess their electrostatic discharge performance. In this experiment, the PET sheets were coated using the manual coating process with no pre-treatment as described in Example 1(i), and the charge of the PET sheets before and after coating were obtained and compared, as shown in FIG. 7. The size of the sheets was ¼ A4 size (dimensions: 6 cm×30 cm).

### (ii) Stainless Steel Surface

### (a) Ethylcellulose Powder

The case study for ethylcellulose was simulated using stainless steel cup coated with 70:30 (PVAc:PVDF) coating solution.

A stainless steel cup coated with a polymer material comprising PVAc and PVDF in a ratio of 70:30 was prepared in the same manner as described in Example 1(ii). The coated stainless steel cup was first cleaned by rinsing it with water and drying it in an oven at 80° C. for 10 min. 0.1 g of ethylcellulose powder was placed into the cup and the powder was agitated using a vortex mixer for 5 min in an environment that had 30% humidity (i.e., in a glove bag purged with nitrogen). 5 min was used for the agitation because it was found that agitating it for a longer duration would not charge the particles higher. After agitation, the coated stainless steel cup was turned upside down to allow the powder to fall off the cup by gravity. A photograph of the inside of the coated stainless steel cup with any remaining ethylcellulose powder on the surface was taken. The electrostatic charge of the powder was measured by dropping the powder into a Faraday cup connected to an electrometer (Keithley 6514) when the cup was turned upside down. Any powder that remained adhered to the surface was knocked off the cup manually into the Faraday cup. The charge of the powder reported thus included all the powder used for agitation in the cup. As shown in FIG. 8(i), the electrostatic charge of ethylcellulose decreased significantly (about 80%) when the stainless steel cup was modified with the non-charging polymer coating. Additionally, visual images of the extent of powder adhesion (FIG. 8(ii)) show that ethylcellulose powder was statically clung to the stainless steel cup. Once the surface was coated with the polymer material, the level of fouling was minimal or eliminated.

### (b) Milk Powder

The case study for milk powder was demonstrated using stainless steel cup coated with 60:40 (PVAc:PVDF) coating solution.

The same procedure described hereinabove for ethylcellulose powder was carried on milk powder. The milk powder was agitated in the same manner in the stainless steel cup coated with the polymer material consisted of PVAc-PVDF as described in Example 1(ii), except that the environment for this experiment was carried out under a humidity of 15%. The milk powder used in this experiment had a strong tendency to absorb moisture. At higher humidity, the moist powder tended to clump together; hence, it was difficult to perform the contact-charging experiment. The experiment was thus performed under a low humidity of 15%.

(iii) Polypropylene Surface

### (a) Aspirin Powder

In this example, PAT probe was used to demonstrate the contact-charging between polypropylene surface and the powder.

The use of PAT as a real-time control tool in pharmaceutical processes has been very widely studied in the academic/R&D space. These studies were mainly geared towards process understanding, early (lab-scale) phase process development or targeted feedback process control. However, PAT is not widely used in pharmaceutical manufacturing due to limitations preventing widespread application.

One such hurdle is the window fouling of the PAT probe. For large scale production, it is frequently reported that the signal from PAT probe is only good for the first few batches. As the particles built up on the probe window, manufacturers would have to either stop the production to clean the probe or rely on offline samples to make manufacturing decisions. As offline testing is often slower and not in real-time, there is a chance that several batches of off specs materials could have been produced before quality control decisions are made based on the offline test results.

### Deployment of Non-Charging Technology

Special considerations need to be taken for the translation of non-charging technology into PAT applications. PAT probes are expensive analytical equipment and are typically shared between multiple processes. The proportion of the first polymer and the second polymer present in the polymer material changes with the type of powder used for a process and hence, additional design considerations are needed to increase the flexibility of the technology deployment.

In this example, aspirin powder was used to demonstrate the contact-charged between the aspirin powder and a coated polypropylene surface (housing). The polypropylene housing of a PAT probe was coated with a polymer material consisted of PVAc and PVDF in a proportion of 45% PVAc-55% PVDF using the same method as described in Example 1(iii). The housing was a cylindrical polypropylene sleeve designed to be fitted tightly onto the body of a PAT probe, covering the tip of the probe with its closed end. The dimension of the housing was 18.4 mm (D)×80 mm (L). The coated polypropylene housing was first cleaned by rinsing it with water and drying in an oven at 80° C. for 10 min. A stainless steel cup insulated on the exterior (i.e., by insulating tape) was also cleaned in the same way.

5 g of aspirin powder was placed in the stainless steel cup. The powder was agitated in the stainless steel cup by a vortex mixer for 5 min. At the same time, the coated polypropylene housing was held by a pair of metallic tweezers such that the closed end of the housing contacted the vigorously moving powder in the stainless steel cup. After 5 min, a photograph of the coated housing with any adhered aspirin powder on the surface was taken. The charge of the powder was measured by knocking off the adhered powder into a Faraday cup connected to an electrometer (Keithley 6514). The humidity was about 65%.

### (b) Polyvinyl Chloride (PVC)

The housing coated with the PVAc-PVDF blend was contact-charged against a piece of bulk polyvinyl chloride (PVC). The housing, which is the cover that forms the outer shell of a PAT probe, is a T-shaped PVC piece of 2 mm thick, 2.5 cm horizontally and 4 cm vertically. The materials were first discharged by a Zerostat gun and were verified to have initial charges of less than ±0.1 nC. After discharging the materials, they were brought into contact for 50 times. The charges of both the materials were measured using a Faraday cup connected to an electrometer. The humidity was about 65%.

Moist aspirin powder with a moisture content of 5% was prepared by adding 0.5 g of deionized water to 9.5 g of aspirin powder. The near-infrared (NIR) spectrum of the wet aspirin was analyzed by immersing the probe of an NIR spectrometer (Bruker, Matrix F, 64 scans) into the wet powder. The probe was then fouled with powder by bringing it into contact with 10 g of vigorously moving dry aspirin powder contained in an insulated stainless steel cup for 5 min (agitated using the same vortex mixer). After fouling the probe, the probe was immediately immersed into the wet aspirin powder again for analyzing its NIR spectrum. A simple baseline correction was performed on both the NIR spectra. The absorbance intensities at wavenumber 6912˜6913 cm⁻¹ (i.e., the characteristic water absorption peak in the NIR region) were converted into moisture content based on Partial Least Square (PLS) model (developed from calibration data) and compared.

### (iv) Glass Surface

### (a) Aspirin Powder

Aspirin powder was agitated on a watch glass that was coated with a polymer material consisted of PVAc and PVDF in a proportion of 45% PVAc-55% PVDF using the same method as described in Example 1(iv). The coated watch glass was first cleaned by rinsing it with water and drying it under a stream of nitrogen gas and left in the open air for about 30 min to dry. 0.03 g of aspirin powder was coated surface of the watch glass. The aspirin powder was agitated by a vortex mixer on the coated watch glass for 5 min. After agitation, the mass of the powder remaining on the watch glass (“initial mass”) was measured again to account for the slight powder loss during agitation.

The watch glass was turned upside down to allow the powder to fall off the watch glass by gravity. A photograph of the inside of the coated watch glass surface with any remaining aspirin powder on the surface was taken. The charge of the powder was measured by dropping the powder into a Faraday cup connected to an electrometer (Keithley 6514) when the watch glass was turned upside down. Any powder that remained adhered to the surface was knocked off the watch glass manually into the Faraday cup. The charge of the powder reported thus included all the powder used for agitation in the watch glass. The percentage mass of aspirin powder adhered to the coated surface was obtained by dividing the final mass by the initial mass. The charge per mass was obtained by dividing the sum of the two charge values by the initial mass.

### (b) Ethylcellulose Powder

Ethylcellulose powder was agitated on a watch glass that was coated with the polymer material consisted of PEO and PVDF in a proportion of 70% PEO-30% PVDF using the same method as described in Example 1 (iv). The coated watch glass was first cleared of any particles and debris with a stream of nitrogen gas. The coated surface was not rinsed with water because PEO is soluble in water. 0.05 g of ethylcellulose powder (250-300 μm) was placed on the surface of the coated watch glass. The ethylcellulose powder was agitated on the coated watch glass by a vortex mixer for 5 min. The percentage mass of the ethylcellulose powder adhered to the coated surface was obtained by dividing the final mass by the initial mass. The charge per mass was obtained by dividing the sum of the two charge values by the initial mass. The humidity was about 65%.

### Example 3

### Characterization and Instrumentation

Elemental analysis to test robustness of the coating was performed by X-ray photoelectron spectroscopy (XPS). The samples were scanned for oxygen, carbon, and fluorine using a Kratos AXIS UltraDLD (Kratos Analytical Ltd) XPS. The base pressure was 1×10⁻⁹ Torr and the working pressure was 5×10⁻⁹ Torr. An X-Ray Source of mono Al Kα hv of 1486.71 eV, 5 mA, 15 kV (75 Watt) was used.

Surface roughness of the stainless steel sheets was measured using a Bruker Dektak XTL™ surface profiler. Stainless steel sheets were dipped in a hot polymer solution at 80° C. for 30 s. They were withdrawn from the solution at a speed of 100 mm/min. Drying of the coated sheets was carried out in an FD −115 oven for 24 h at 50-80° C. The thickness of the coating on the stainless was measured using a 45 MG ultrasonic thickness gage with a 10 MHz probe. Three sections of each sheet were scanned.

### Results

Three polymers have been identified in the present invention as suitable candidates for preparing the polymer material and these include polyvinyl acetate (PVAc), polyethylene oxide (PEO) and polyvinylidine fluoride (PVDF). As described hereinabove, for the preparation of a non-conductive polymer material for aspirin and milk powders, a blend comprising PVAc and PVDF was prepared. For the preparation of a non-conductive polymer material for ethylcellulose, a blend comprising PVAc and PVDF or PEO and PVDF was prepared. These blends are generally acceptable under government regulations for use in food and pharmaceutical products. On the other hand, other methods of preparing the polymers (e.g., copolymerization) may require additional regulatory approval.

### (i) Coated Polyethylene Terephthalate (PET) Surface

The results in Example 2(i) show that all sheets had a significant decrease (about 90%) in electrostatic charge. A regular PET sheet has a high average charge of about −17 nC. After applying the non-charging coating solution on one side of the sheet, the charge reduced by more than 4 times to an average of −4 nC. When both sides were coated, the charge reduced further to a level that is closed to zero. This shows that the non-charging coating solution has effectively eliminated the surface charge on regular PET sheets.

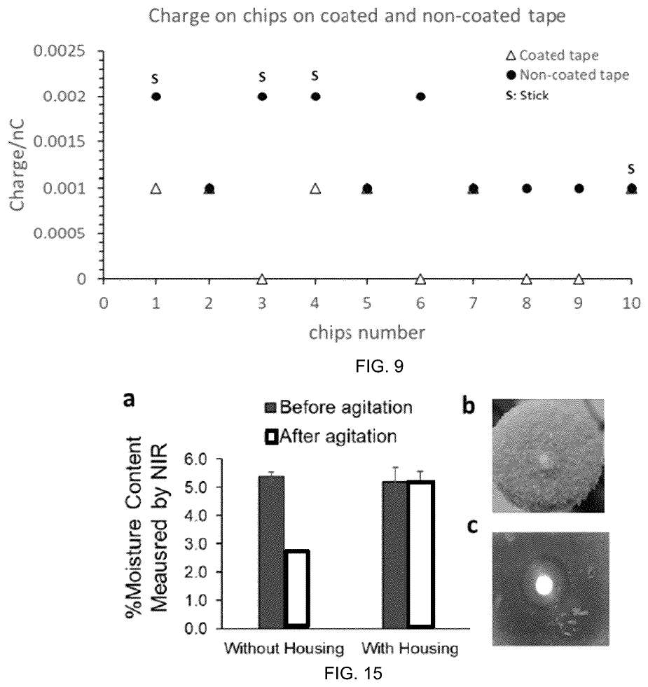

Additional testing was done using smaller chips of dimensions of 2.5 mm×1.5 mm (weight=0.097 g). The same tests as FIGS. 5 and 6 were conducted, and the results are shown in FIG. 9.

In FIG. 9, same pattern was observed (per FIGS. 5 & 6). Higher electrostatic charge was observed on chips that were packed in regular cover tape, especially those that clung onto the cover tape. Chips packaged in non-charging cover tape did not cling onto the cover tape and had significantly lower electrostatic charge. This shows that the technology is effective and can work with electronic chips regardless of their size.

As opposed to existing methods that use conductive methods to conduct charge away, the present invention works by eliminating the generation of electrostatic charge at source.

### (ii) Coated Stainless Steel Surface

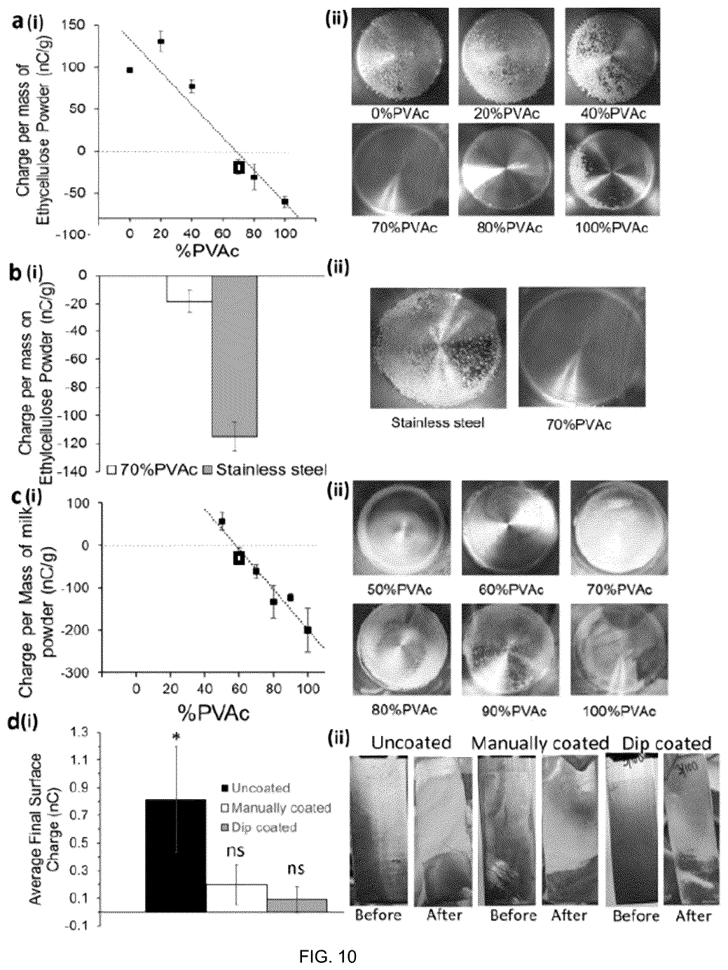

In the contact-charging Example 2(ii)(a) carried out on coated stainless steel surface using ethylcellulose powder, it was found that at 70% PVAc, ethylcellulose powder did not charge by contact electrification (part (i) of FIG. 10a). As a result, most of the powder fell off when the stainless steel cup was flipped (part (ii) of FIG. 10a). In contrast, almost all the powder remained adhered to the coated surface of the cup for all other percentages of the polymer blend. The experiment was also repeated for uncoated stainless steel. In this case, the charge of the ethylcellulose powder was considerably much higher than when the cup was coated with the polymer blend that consisted of 70% PVAc (part (i) of FIG. 10a). The amount of powder that remained adhered to the surface of the uncoated stainless steel was correspondingly much larger as well (part (ii) of FIG. 10b).

To demonstrate the generality of the present invention, milk powder was agitated in the coated stainless steel cup instead of the ethylcellulose powder. Similarly, the experiment for cups coated with different proportions of PVAc and PVDF was repeated. It was found that when the coat of polymer material consisted of 58.6% PVAc, the milk powder did not charge by contact electrification (part (i) of FIG. 10c, see the figure showing 60% PVAc)). As a result, most of the powder fell off when the stainless steel cup was flipped (FIG. 3cii), as expected. In contrast, at other percentages of PVAc, virtually all the powder remained adhered to the polymer coated stainless steel surface.

The surface charge of the substrate was also measured, which in this case, stainless steel sheets was used. A near zero initial charge was measured on the stainless steel sheet (3 mm×2.5 cm×7.5 cm). The measurement was done by lowering the metal sheet into the Faraday cup using a wooden test tube holder. The metal piece was transferred into a glass jar (5 cm diameter) filled with milk powder and agitated using a vortex mixer at 2000 rpm for 5 min. The jar was tilted at 45 degrees during agitation. The jar was opened and the metal piece was transferred using wooden test tube holder into Faraday cup for final charge measurement. The final surface charge of the uncoated, manually coated and the dip coated stainless steel sheets are shown in FIG. 10d(i). From the results, we can see that the uncoated stainless steel sheet carries the highest charge, while the coated stainless steel sheets are respectively lower. Consequently, the amount of powder adhered to the surface of the uncoated sheet is the highest as well, as compared to the coated sheet. The results also seem to suggest that dip coating the stainless steel sheet results in a lower surface charge compared to manually coating the stainless steel sheet. This could be the result of a smoother surface produced by the consistent speed of the dip coater during the coating process as compared to a manual coating process. A two-tailed paired t-test was also performed to determine if there is any significant change in charge before and after contact with the milk powder. If p-value is below 0.05, there is a significant change in charge after contact with powder and this is the case for the uncoated sheet while the change is not significant (ns) for both the manually coated and the dip coated sheets.

### To Show Adhesion of Particles is Due to Electrostatic Force Between Charged Particles and Surfaces

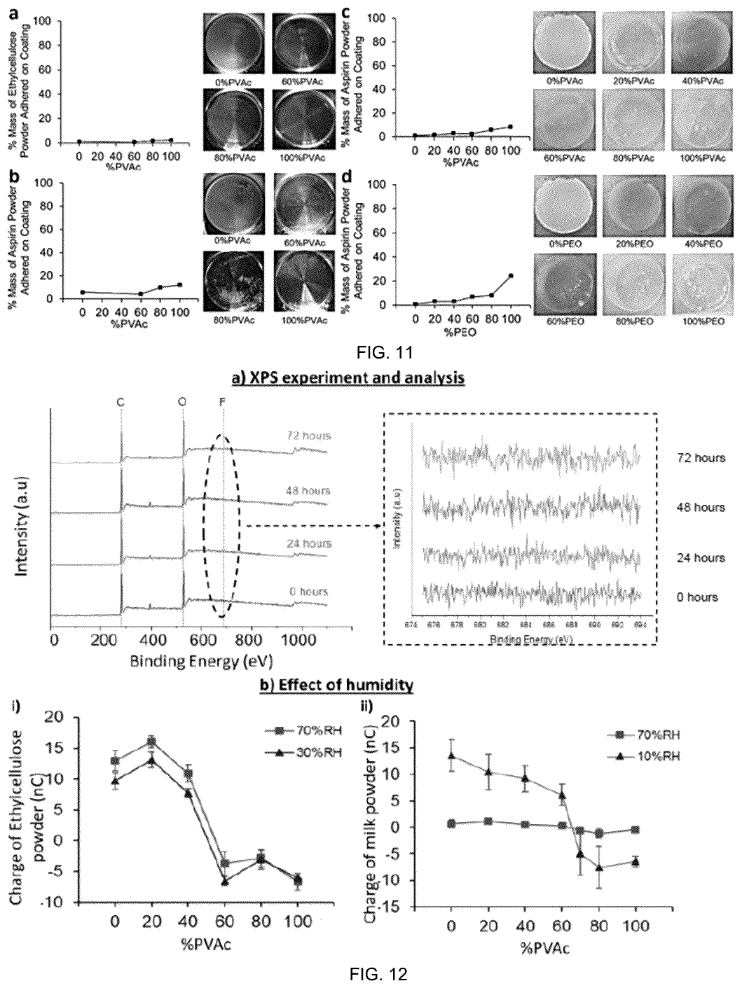

An experiment was also carried out to determine whether the adhesion of particles was indeed due to the electrostatic attractive force between the charged particles and the surfaces and not due to other mechanisms (e.g., van der Waals forces between the particles and the surface). For this experiment, 0.1 g of aspirin powder was placed into a stainless steel cup coated with the PVAc-PVDF polymer blend in a proportion of 45% PVAc-55% PVDF. In this case, however, the powder was not agitated in the cup: after placing the powder into the cup, the cup was immediately turned upside down and the powder was allowed to fall off by gravity. It was found that for all cases—including the cups that were coated with pure 100% PVAc and 100% PVDF—almost all the powder fell off the surfaces (FIG. 11a). This shows that agitation was absolutely necessary for charging the particles (and the surface) by contact electrification; however, it might not be necessary for other types of binding forces, including van der Waals forces. Hence, this experimental result suggests strongly that the adhesion was due to the attractive electrostatic force produced by the charged materials via contact electrification. The experiment was repeated with ethylcellulose powder and similar results were observed.

### Characterization of the Coating

### Roughness and Thickness

For food and pharmaceutical manufacturing facilities, there are strict requirements on product contact surfaces. PVDF and PVAc are listed on the US Food and Drug Administration (FDA) approved list for food contact materials. Therefore, it is generally safe to use these materials on food processing surfaces. To ensure the non-charging material would not contaminate the food/pharma product, the robustness of the coating on the stainless steel vessel was investigated.

The surface roughness and thickness of the polymer blend coating were measured using a surface profiler (Bruker Dektak XTL™). In this experiment, stainless steel sheets were coated using a dip coater machine. A dipping method was used in this example because the stainless steel sheets are flat, so it allows coating to be carried out using a dip coater. The results show that the average thickness of the coating is around 0.031±0.002 mm.

Surface roughness of the stainless steel sheets was measured, and P0 is where the scan begins on the sheet, as shown in FIGS. 12(a), and P2 is the end. Scans are in one direction. P1 is the point where the coating begins, hence the bump on the surface profile. The dip coated polymer stainless steel surface is generally smooth as demonstrated by the surface profiler measurements with very minimum deviations (FIG. 12b (5b) and the largest deviation is only 50 μm. Hence, the root mean square (RMS) value of the surface roughness is 62. It is important to ensure that the coating on the surface was robust enough and did not wear off easily. For food and pharmaceutical manufacturing facilities, there are strict requirements that no additional materials are to be introduced in the process for contaminating the food or drug products. Accordingly, the robustness of the coating that consisted of PVAc and PVDF in a proportion of 58.6% PVAc-41.4% PVDF on the stainless steel cup was investigated.

Experimentally, fresh milk powder was agitated in a coated stainless steel cup continuously for 72 hours using an orbital shaker that was operated at 350 rpm. Samples of the milk powder were then taken at the beginning, Day 1, Day 2, and Day 3 of agitation, and analysed using X-ray photoelectron spectroscopy (XPS). Results of the analysis show that there are no fluorine peaks for all samples (FIG. 12a). Fluorine was present in the coating that consisted of PVDF. Hence, this result shows that no material from the coating was transferred to the milk powder. This polymer blend is thus safe for use on surfaces in manufacturing processes.

### Effect of Humidities

An important property of the coating to understand is its dependence on humidity. Humidity in a manufacturing facility can vary greatly depending on its location in the world and the season of the year. The effect of humidity on two types of powders: the ethylcellulose powder and milk powder were investigated. Each of the powders was agitated in a stainless steel cup coated with PVAc-PVDF blend of different proportions at different humidities. The two types of powders performed differently. For ethylcellulose powder, the magnitudes of charge generated on the powder after agitation were similar when the experiment was performed in an environment with both high (i.e., 70%) and low (i.e., 30%) humidity (part (i) of FIG. 12b). For milk powder, however, the magnitude of charge generated was drastically lower when the experiment was performed in an environment with high humidity (i.e., 70%) than low humidity (i.e., 15%) part (ii) of FIG. 12b). Because milk powder has a strong tendency to absorb moisture, the wet surface of the particles in an environment with high humidity may allow any charge generated to be dissipated away rapidly. Regardless of the characteristic of the powder, it was found that the composition of the polymer blend that produced the noncharging effect remained unchanged with different humidities (i.e., about 65% PVAc for ethylcellulose and about 60% PVAc for milk powder). Therefore, the approach of using the noncharging polymer blend is effective for environments with different humidities.

(iii) Coated Polypropylene Surface

### (a) On PAT Probe

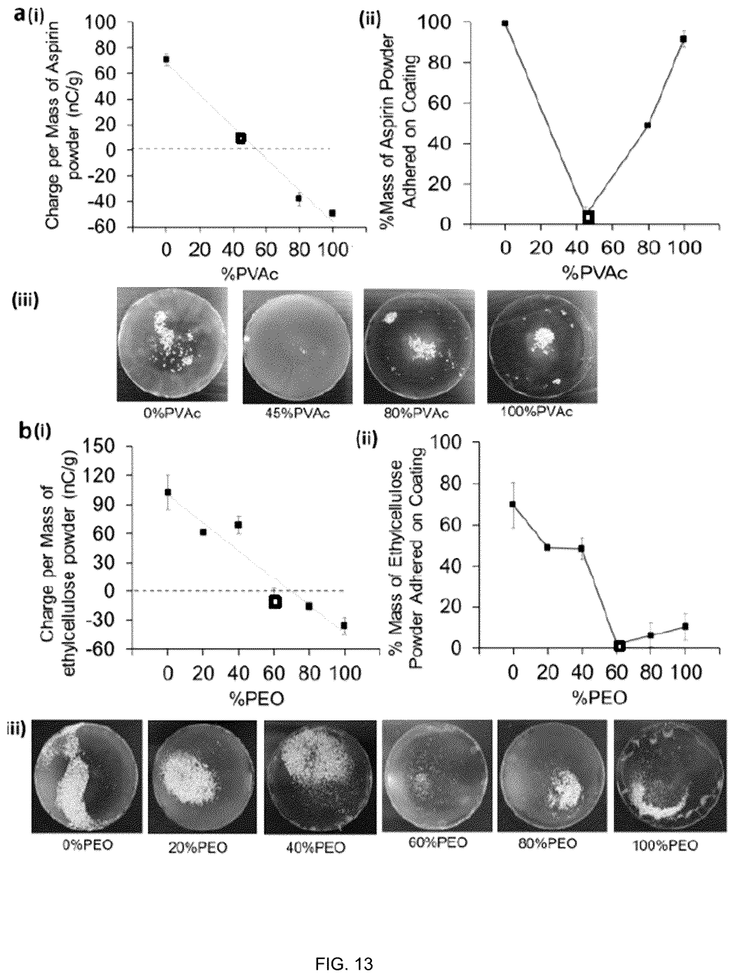

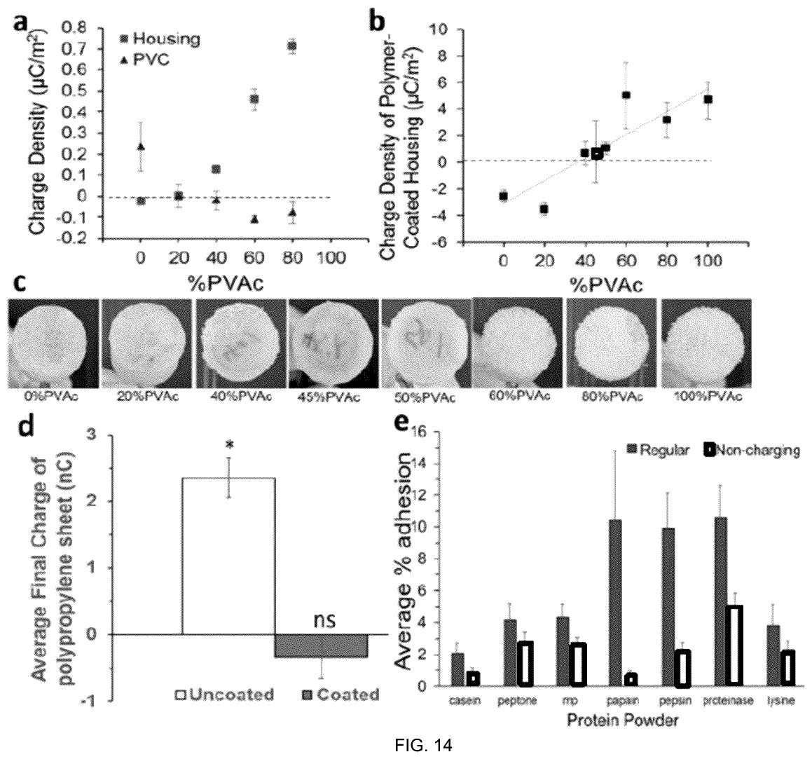

The generality of non-charging polymer blend was demonstrated by coating it on a flat polymeric substrate. To associate the demonstration with a practical application, the polymeric substrate used was a housing for a near infrared (NIR) probe. Process Analytical Technology (PAT), such as the NIR probe, is commonly used in the pharmaceutical industry. The housing is the same as described in Example 1(iii). Polypropylene (PP) has a cap-like geometry which is also referred to as ‘housing’. The polymer blend was coated by dip-coating the entire outer surface of the probe. Contact electrification experiment between the aspirin powder and the polymer blend was carried out by contacting the coated housing with 10 g of vigorously shaken powder (contained in an insulated stainless steel cup). Instead of measuring the charge of the powder, the charge of the coated housing after contact was measured. This was because it was found that the charge of a coated housing is more representative as there is a large amount of powder in the cup, and the housing only contacted the powder that circulated within the cup and a small fraction of it. Not all the powder contacted only the housing. The results show that the housing coated with 40%, 45%, and 50% PVAc did not charge highly by contact electrification (FIG. 14 (7b). This result is consistent with the experiment in which aspirin powder did not charge against the surface of watch glass coated with a polymer blend that consisted of 45% PVAc (FIG. 13 (6). These coatings with compositions of 40-50% PVAc allowed only little amounts of particles to stick onto their surfaces (FIG. 13 (6c). In contrast, thick layers of the powder were observed to be coated onto the polymer blends of other compositions—fouling of the surface occurred.

### To Show Adhesion of Particles is Due to Electrostatic Force Between Charged Particles and Surfaces

An experiment was carried out to verify that the fouling of the coated surface of the housing was due to the attractive electrostatic force and not due to other types of forces. For this experiment, the housing coated with 100% PVAc with aspirin powder was first fouled. Ions were then released toward the fouled surface of the housing using a Zerostat gun. The Zerostat gun releases both positive and negative ions that are usually used for discharging materials. After releasing the ions, it was observed that a significant amount of the adhered aspirin powder fell off the coated surface. This result indicated that the powder adhered to the coated surface by the attractive electrostatic force between the particles and the polymeric surface.

When fouling occurred on the housing, the analysis by the probe can be highly inaccurate. This effect was proved to occur by first allowing the bare NIR probe (i.e., without the polypropylene housing) to foul. Specifically, the bare probe was immersed in an insulated stainless steel cup with aspirin powder containing 5% moisture content. The stainless steel exterior of the probe seemed to allow the powder to foul readily upon contact and agitation. The probe was then used to measure the moisture content of a sample of aspirin powder specifically wetted with 5% of water. Before fouling the probe, it measured the moisture content of this sample accurately (FIG. 15a (8a). However, after fouling, the probe measured the moisture content of the sample of wet aspirin powder to be about 2.5%—a value that was around half that of the actual moisture content of the sample. When the dry powder adhered to the surface of the probe, the particles blocked the light from being emitted from the probe, thus interfering with the analysis (FIG. 15b (8b). On the other hand, when the probe was covered with the housing coated with the non-charging polymer material that consisted of 45% PVAc and was agitated for 5 minutes with 5% moisture content aspirin powder contained in an insulated stainless steel cup, no adhesion of the powder to the probe was observed (FIG. 15 (8c). Consequently, the coated housing remained clean and light was able to emit through brightly from the NIR probe tip (FIG. 15 (8c). Without any adhesion of powder to the housing, the probe was able to measure the moisture content of the sample of aspirin powder wetted with 5% water accurately before and after contacting with the dry aspirin powder.

### (b) On PAT Probe in Batch Process

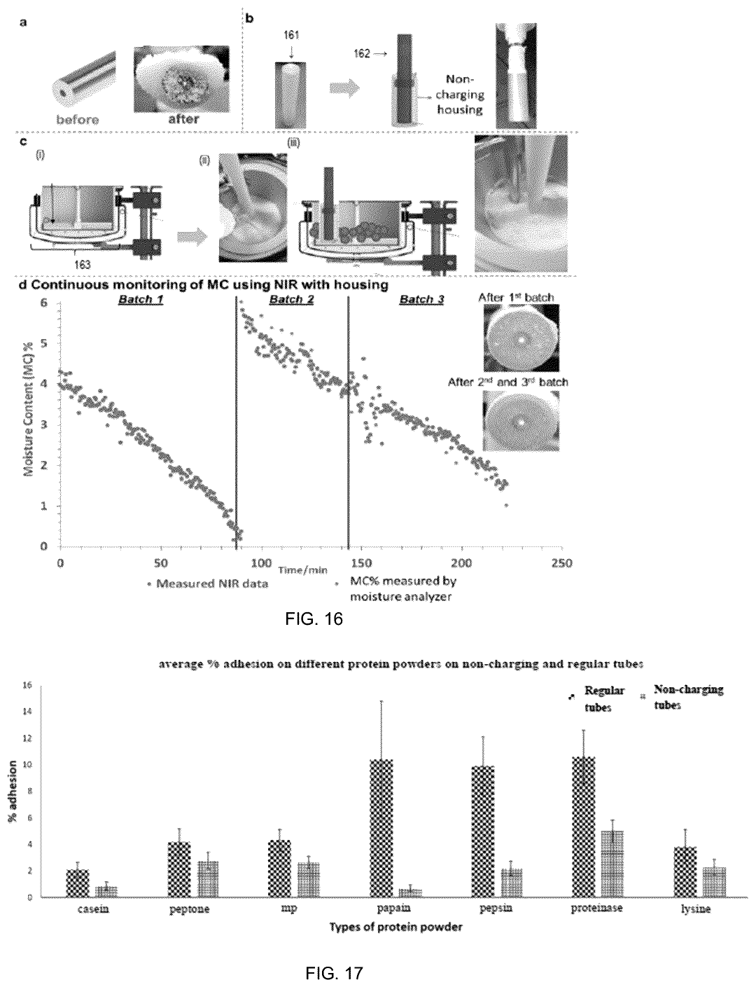

To further validate the applicability of the technology in a real industrial process, an experiment using the non-charging housing of the PAT probe in a continuous batch drying process was carried out. Specifically, the experiments were carried out in a standard commercialized glass filter dryer (GFD; PSL StepBioS) to dry three continuous batches of aspirin powder. A commercially available NIR probe was used to measure the moisture content. Fouling occurred on the bare NIR probe where aspirin powder adhered to the probe tip, as shown in FIG. 15, resulting in inaccurate measurement of moisture content. This is further validated in the later section that follows, where it showed that fouling blocked the light from emitting through the NIR probe tip (FIG. 16a). A cylindrical structured polypropylene cover was designed, which was referred to as “housing”, the same housing there was mentioned hereinabove in Example 2(iii)(a), to be tight fitted onto the PAT probe. As described in the method hereinabove above, the non-charging polymer solution was coated onto the housing via plasma treatment (2 min) and the housing was dip coated with the polymer blend comprising 45% PVAc and 55% PVDF before drying at 70° C. for 20 min. The dried coated housing was then fitted onto the NIR probe tip (FIG. 16b). 475 g of Aspirin powder and 25 g of water were measured to make up 5% moisture content of the mixture. The mixture was poured into the filter basket of the GFD containing the stirring shaft (FIG. 16c).

The NIR probe fitted with the non-charging housing was lowered into the basket of the GFD. The temperature was then turned on to 80° C., to supply heat from the heated jacket wrapped around the basket to further decrease drying time. The mixing of the aspirin powder was by the stirring of the shaft at a rate of 25 rpm. 0.05 g of powder was sampled from the mixture every 5 min for the measurement of moisture content manually using a moisture analyzer, while the continuous monitoring of moisture content by the NIR was ran concurrently. When the offline moisture content measurement dropped to 0.8% for the first batch, another 25 g of water was added for the second batch of drying process. This was to show that even after large changes in moisture content and multiple batches of drying on a prolonged period of time, the non-charging probe can still measure the moisture content accurately. After the third batch of drying has finished, the experiment was halted. Using a prepared set of calibration values, the moisture content measured by the NIR probe in the drying process was predicted using the PLS model through the software MATLAB. The moisture content values obtained offline using the moisture analyzer and the online values measured by the NIR probe were then plotted and compared against each other.

The offline and online moisture content values have shown to match well with each other, as shown in FIG. 16d. The matching values were accompanied by pictures of the relatively clean housing after the first and the third batch. The pictures of the coated housing after the batch drying process in FIG. 16d show much lesser adherence of the powder as compared to on the bare probe (FIG. 16a). This proved that the coated housing successfully prevented fouling, allowing the detection of moisture content values to be accurate.

### (iv) Coated Watch Glass

Besides coating on stainless steel cup, coating of the non-conductive polymer blend on a curved watch glass (diameter: 45 mm) was also tested. The surface of the watch glass was first dip-coated with a layer of the polymer material that consisted of various proportions of PVAc and PVDF. Aspirin powder was then agitated on the surface of the coated watch glass. The results show that the aspirin powder did not charge by contact electrification on the watch glass coated with a polymer blend that consisted of 45% PVAc (FIG. 13a). Almost all powder was observed to have fallen off by gravity when the watch glass was flipped upside down (part (ii) and (iii) of FIG. 13a). On the other hand, the powder tended to adhere to polymer blends of other compositions; in particular, almost all the powder adhered to the surfaces coated with the pure polymers, that is, 100% PVAc and 100% PVDF.

The experiment was repeated using ethylcellulose powder and pieces of watch glass coated with the PEO-PVDF blend of different compositions were prepared and tested (FIG. 13b). In this case, the results show that the ethylcellulose powder did not charge by contact electrification on the watch glass coated with a polymer blend that consisted of 60% PEO. With this composition, only little amount of the powder adhered to the coated surface after the watch glass was flipped upside down. On the other hand, other compositions of the polymer blend allowed a lot more powder to be adhered to the coated surface.

### To Show Adhesion of Particles is Due to Electrostatic Force Between Charged Particles and Surfaces

Another experiment was carried out using aspirin powder to verify again that the adhesion of powder to the surface of a coated watch glass was due to the attractive electrostatic forces and not due to other types of binding forces, including van der Waals forces. This experiment involved placing aspirin powder on a watch glass coated with either the PVAc-PVDF or PEO-PVDF blend. Similarly, the watch glass was flipped upside down immediately after placing the aspirin powder on the surface of the watch glass (i.e., without agitating the powder on the surface). For the PVAc-PVDF blends in various proportions comprising PVAc in 0%, 20%, 40%, 60%, 80%, 100% by weight, the results show that there was little adhesion of the aspirin powder to the coated surface for all the different proportions of the polymer material coated on the watch glasses (FIG. 11c). For the PEO-PVDF blends in various proportions comprising PEO in 0%, 20%, 40%, 60%, 80%, 100% by weight, the results were similar, except for the coating that involved 100% PEO (FIG. 11d). The pure PEO coating may charge highly against the aspirin powder; hence, the slight movement of the powder on the coated surface when the watch glass was flipped might still charge the powder sufficiently for allowing the powder to adhere to the coated surface.

### Example 4

### Powder-Surface Contact Dynamics and Bulk Contact of PVC With Coated Housing

A contact experiment between the housings of PAT probes coated with PVAc-PVDF blend and a piece of bulk polyvinyl chloride (PVC) (FIG. 14) was performed. The experiment procedures are as follows:

Firstly, the coated housings and the PVC piece were discharged using a Zerostat gun (initial charge <±0.1 nC). After discharge, the materials were brought into contact for 50 times. The charges of both the materials were then measured using a Faraday cup connected to an electrometer. The humidity for conducting the contact electrification experiments was about 65%. The results show that there is zero charge on both the 20% PVAc coated housing and the PVC piece when they contacted. Moreover, the charge trend of the PVC piece and the coated housing goes in opposite direction respectively, where one is negatively charged, the other would be positively charged. The two trends ultimately meet at the point of 20% PVAc, where there is zero charge measured on both objects. This shows that the technology and material of the present invention can be applied to bulk materials. More importantly, it proves the ability of the technology eliminating static just through simple contact without having to apply the coating directly onto the reference material which might cause undesirable permanent modification.

A near zero initial charge was measured on a polypropylene sheet (3 mm×2.5 cm×7.5 cm). The measurement was done by lowering the polypropylene sheet into the Faraday cup using a wooden test tube holder. The propylene sheet was transferred into a glass jar (5 cm diameter) filled with milk powder and agitated using a vortex mixer at 2000 rpm for 5 minutes. The jar was tilted at 45 degrees during agitation. The jar was opened and the polypropylene sheet was transferred using wooden test tube holder into Faraday cup for final charge measurement. The final surface charge of the uncoated, and coated polypropylene sheets are shown on FIG. 14d. The uncoated polypropylene sheet carried a much higher charge than the coated sheet. A two-tailed paired t-test was performed to determine if there is any significant change in charge before and after contact with the milk powder. If p-value is below 0.05, there is a significant change in charge after contact with powder and this is case for the uncoated sheet while the change is not significant (ns) for the coated sheet.

### Example 5

### Fouling Issue in Powder Storage Tubes

### Background of Problem

Powders are also commonly used in research, where they are stored or transferred using plastic tubes. When it is handled under dry environments, charge build-up on the powder/tubes leads to powder adhesion (on transfer/working surfaces, storage tubes, etc.). While this adhesion problem exists in most powders, the problem is most severe for lyophilized enzyme and protein powders. A practical example is the production of custom recombinant proteins, which can cost thousands of dollars or more per mg. After the custom protein is produced by yeast or E. coli cells, the solution is lyophilized to produce a stable dry protein powder. The amount of powder produced is often minute, in the milligram range. It is known the powder tends to stick to the tube walls or cap after production and shipping, leading to possible loss on the end user's part. Given the extremely small amounts and high cost of these powders, even loss of a few grains can be very costly and wasteful. It is thus necessary to minimise powder adhesion to the tubes.

### Modification of Tube Surfaces

Commercially available centrifuge tubes/sample tubes in varying volumes (1.5, 15, 50 mL) were purchased. Similar to the coating on the stainless steel cups, the non-charging coating solution was then coated onto the tubes via plasma treatment (4 min) and dip coating (90:10, PVAC:PVDF). The tubes were loaded upside down into a rack and placed into the oven at 90° C. and dried for 30 minutes.

Mass adhesion tests were performed on the coated tubes. To induce electrostatic charging, powder was agitated in the tube using a vortex mixer for one minute. The tube was then turned upside down. The loose powder fell off and the weight of the powder that was statically clung to the tube surface was measured and expressed as the percentage (%) adhesion.

The percentage (%) adhesion was calculated by dividing the amount of powder that clung onto the tube over the total amount of powder added (prior to electrostatic charging). Seven different protein powder were tested and the results are as shown in FIG. 17. These powders were a mix of proteins (casein, milk protein, etc.), enzymes (papain, pepsin, proteinase, etc.) and amino acids (peptone, lysine, etc.) from various sources, as a representative selection of commercially available powder types.

For all the powders tested, the percentage (%) adhesion of the powders on the non-charging tube is much lower than on the regular tube. As these powders can be very expensive in general, any loss due to adhesion is very costly. For example, handling around 100 mg of proteinase in a regular tube leads to an average loss of 11.68 mg due to adhesion, a total cost of 8 cents per 100 mg. Using the same amount with a non-charging tube leads to a loss of only 5.56 mg, for total savings of around 4.5 cents per 100 mg. As the value of the powder increases, the savings will also increase. This shows that the non-charging tube technology can be generally applied to different types of protein powders, demonstrating the high versatility and applicability of this technology to the research field.

With the use of the non-conductive polymer material of the present invention in accordance with the method of the present invention, several commercial problems can be alleviated or solved, and these problems include, material loss due to particles or powders adhered to the equipment surface; productivity loss due to the need to pause time-to-time for cleaning of apparatus and machines due to fouling; high maintenance cost due to fouling; difficulties in implementing inline process monitoring tools as the accuracy of the process analytical tools, such as the NIR spectroscope, deteriorates as the sensor window fouls; adsorption of proteins to glass and plastic surfaces which results in material loss and inaccurate material transfer; sparks or fires which may be caused by electrostatic charge from powders and protein powders which tend to accumulate charges easily; binding of small proteins to plastics such as polypropylene tubes and plates which are used in experiments involving collection of data relating to plasma protein binding values.

### Results

In conclusion, the present invention is introducing a general method for fabricating polymer material that resists charging against another material based on physically blending of two polymers together. This is done by mixing an appropriate proportion of a first polymer that has the tendency to charge positively and a second polymer that has the tendency to charge negatively and using a common solvent as a medium. The inventors have successfully tuned the formulations to eliminate the generation of charge for the various types of powders. The coating of the polymer material resists charge against particles or powders and thereby prevent the particles or powders from adhering to the coated surface. Importantly, these formulations are also non-conductive—a characteristic contrary to common existing solutions to mitigate electrostatic charge where surfaces are made to be conductive. Conductive materials usually conduct charge away only after charge has been generated after contact, while the non-conductive formulated polymer material of the present invention is able to eliminate the generation of charge at the source in the first place. The polymer material also does not require further modification or addition of other substances (e.g., dopants or agents), and the method of blending is simple, general and conveniently flexible to be applied over a range of applications, as demonstrated in the Examples described hereinabove.

There are several advantages of the various embodiments of the polymer materials that are applied as coatings for preparing non-conductive surfaces. (1) The non-conductive polymer material resists charge against different types of pharmaceutical and food powders. The examples described hereinabove also used surfaces of different materials, such as glass and polypropylene. The surfaces also take on different structures and geometries, such as vessels with vertical walls, curvatures and flat surfaces. Hence, the coatings are highly versatile and can be flexibly applied to surfaces of virtually any type of materials. Importantly, the non-conductive polymer material is able to coat well on materials which are common industrial equipment surfaces like stainless steel. The robust coating also exhibits desired non-charging property against commercially available powders, namely ethylcellulose, aspirin and milk powder; (2) The polymers used in the present invention are also FDA-approved pharma and food contact materials, and the method through which the blend is formulated does not require additional regulatory approval. Hence, the non-conductive polymer material is ready and safe to be applied onto current existing facilities in the pharmaceutical and food manufacturing process dealing with the aforementioned powders; (3) Notably, the charge of the contacting surface is also reduced; (4) Surface coating ensured that the bulk properties of the materials are not altered; (5) The method of coating is simple: the materials are only to dip in a solution containing the polymer blend solution, allowing potentially easy scale-up to coat a large surface area; (6) The non-conductive polymer material is generally inexpensive; (7) The non-conductive polymer material is robust and do not wear off easily, preventing cross contamination to food and pharmaceutical powders. Importantly, the inventors have demonstrated that the non-charging surface works well even through using a thin coating, without having to replace the underlying substrates which consist of materials commonly used in the industry. This shows that technology of the present invention can be easily and readily translated for use in industrial settings. The method and materials used have fully met stringent requirements in order to be translated into the relevant industries. As many of the existing solutions have yet to fully eliminate the problem of electrostatic charge, solution offers by the present invention provides a way for total elimination of electrostatic charge to be realized and made possible. With the successful integration of this technology in a simulated real life industrial process, this technology has proven to be able to solve many of the complicated electrostatic charge issues faced by the industries today.

Although embodiments of the present invention have been shown and described, the present invention is not limited to the described embodiments. Instead, it would be appreciated by those skilled in the art that changes may be made to the embodiments without departing from the scope of the invention, the scope of which is set forth in the following claims.

1. A non-conductive polymer material for applying a non-conductive coat to a surface, the non-conductive polymer material comprising:
a first polymer selected from the group consisting of polyvinyl acetate and polyethylene oxide;
a second polymer being polyvinylidene fluoride; and
a solvent selected from the group consisting of dimethyl sulfoxide, tetrahydrofuran, toluene and dimethylformamide.

2. The non-conductive polymer material according to claim 1, wherein the first polymer is polyvinyl acetate and the second polymer is polyvinylidene fluoride.

3. The non-conductive polymer material according to claim 2, wherein the first polymer is present in the non-conductive polymer material in an amount of 40% to 85% based on the total weight of the non-conductive polymer material.

4. The non-conductive polymer material according to claim 1, wherein the first polymer is polyethylene oxide and the second polymer is polyvinylidene fluoride.

5. The non-conductive polymer material according to claim 4, wherein the first polymer is present in the non-conductive polymer material in an amount of 55% to 70% based on the total weight of the non-conductive polymer material.

6. The non-conductive polymer material according to claim 1, wherein the solvent is dimethylformamide.

7. A method of eliminating electrostatic charge on a surface, the method comprising:
applying at least one layer of a non-conductive polymer material comprising:
a first polymer selected from the group consisting of polyvinyl acetate and polyethylene oxide;
a second polymer being polyvinylidene fluoride; and
a solvent selected from the group consisting of dimethyl sulfoxide, tetrahydrofuran, toluene and dimethylformamide,
to at least one surface of an object to form a non-conductive coat on the surface.

8. The method according to claim 7, further comprising subjecting the surface to plasma treatment prior to applying the non-conductive polymer material on the at least one surface of the object.

9. The method according to claim 7, wherein the first polymer is polyvinyl acetate and the second polymer is polyvinylidene fluoride.

10. The method according to claim 9, wherein the first polymer is present in the non-conductive polymer material in an amount of 40% to 85% based on the total weight of the non-conductive polymer material.

11. The method according to claim 7, wherein the first polymer is polyethylene oxide and the second polymer is polyvinylidene fluoride.

12. The method according to claim 11, wherein the first polymer is present in the non-conductive polymer material in an amount of 55% to 70% based on the total weight of the non-conductive polymer material.

13. The method according to claim 7, wherein the solvent is dimethylformamide.

14. The method according to claim 7, wherein the method comprises applying the at least one layer of the non-conductive polymer material to the at least one surface made of material selected from the group consisting of thermoplastic polymer, stainless steel and glass.

15. The method according to claim 14, wherein the thermoplastic polymer is selected from the group consisting of polypropylene, polyethylene terephthalate and polyethylene.

16. The method according to claim 7, wherein the at least one surface is an internal surface of a receptacle.

17. The method according to claim 7, wherein the at least one surface is a surface of a film or a cover tape.
